(19) United States
(12) Patent Application Publication
(10) Pub. No.: US 2011/0223891 A1
(43) Pub. Date: Sep. 15, 2011

(54) SYSTEM AND METHOD FOR EXCHANGING INFORMATION

(76) Inventor: ARAM KOVACH, LEWIS CENTER, OH (US)

(21) Appl. No.: 13/045,792

(22) Filed: Mar. 11, 2011

Related U.S. Application Data
(63) Continuation-in-part of application No. 12/860,883, filed on Aug. 21, 2010.
(60) Provisional application No. 61/313,109, filed on Mar. 11, 2010.

(51) Int. Cl. H04M 3/42

(52) U.S. Cl. 455/414.1

(57) ABSTRACT

A system for exchanging information. At least one cellular telephone has a data acquisition device, a receiver and a transmitter. An electronic communication network receives acquired data transmitted by the cellular telephone and re-transmits the data to at least one remote server. A data decoding device accessible to the remote server decodes the data and generates a corresponding dataset. A processor accessible to the remote server generates a response corresponding to the dataset, the response being forwarded from the remote server to the receiver of the cellular telephone by means of the electronic communication network.

This application is a continuation-in-part application claiming priority to U.S. patent application Ser. No. 12/860,883, filed Aug. 21, 2010. This application also claims priority to U.S. Provisional Patent App. No. 61/313,109, filed Mar. 11, 2010. This application incorporates by reference the entire contents of both U.S. patent application Ser. No. 12/860,883 and U.S. Provisional Patent App. No. 61/313,109.

### FIELD

The present invention relates generally to cellular telephones, in particular to a system that utilizes camera-equipped cellular telephones to send data acquired by the cellular telephone and to receive information corresponding to the data.

### BACKGROUND

Camera-equipped cellular telephones have become commonplace. However, the image-capturing capability of these cellular telephones is typically utilized merely to record images and share them with others. There is a need for a way to utilize the image-capturing capability of camera-equipped cellular telephones to serve as a data input device. There is a further need for a way to utilize data relating to the captured image to provide information and services. There is yet a further need for cellular telephones to be coupled to various types of data acquisition sensors and to utilize the acquired data to obtain desired information.

### SUMMARY

The present invention discloses various embodiments of a system that utilizes camera-equipped cellular telephones to send images and other data acquired by the cellular telephone and to receive information and services relating to the images and data. Example embodiments include information relating to text translations, postage stamps and vehicle tires. Additional example embodiments include social network utilities and vehicle accident reporting utilities.

An object of the present invention is a system for exchanging information. The system comprises at least one cellular telephone having a data acquisition device, a receiver and a transmitter. An electronic communication network receives acquired data transmitted by the cellular telephone and re-transmits the data to at least one remote server. A data decoding device accessible to the remote server decodes the data and generates a corresponding dataset. A processor accessible to the remote server generates a response corresponding to the dataset, the response being forwarded from the remote server to the receiver of the cellular telephone by means of the electronic communication network.

Another object of the present invention is a method for exchanging information. Data is acquired using a cellular telephone equipped with a data acquisition device. An electronic communication network is utilized to transmit the acquired data to at least one remote server. The data is decoded at the remote server to generate a corresponding dataset. The dataset is processed at the remote server in a predetermined manner to generate a response corresponding to the dataset. The response is sent from the remote server to the cellular telephone by means of the cellular network.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is a diagram of a system utilizing sensor-equipped cellular telephones according to an embodiment of the present invention;

FIG. 2 provides details of sensing methodologies usable with the system of

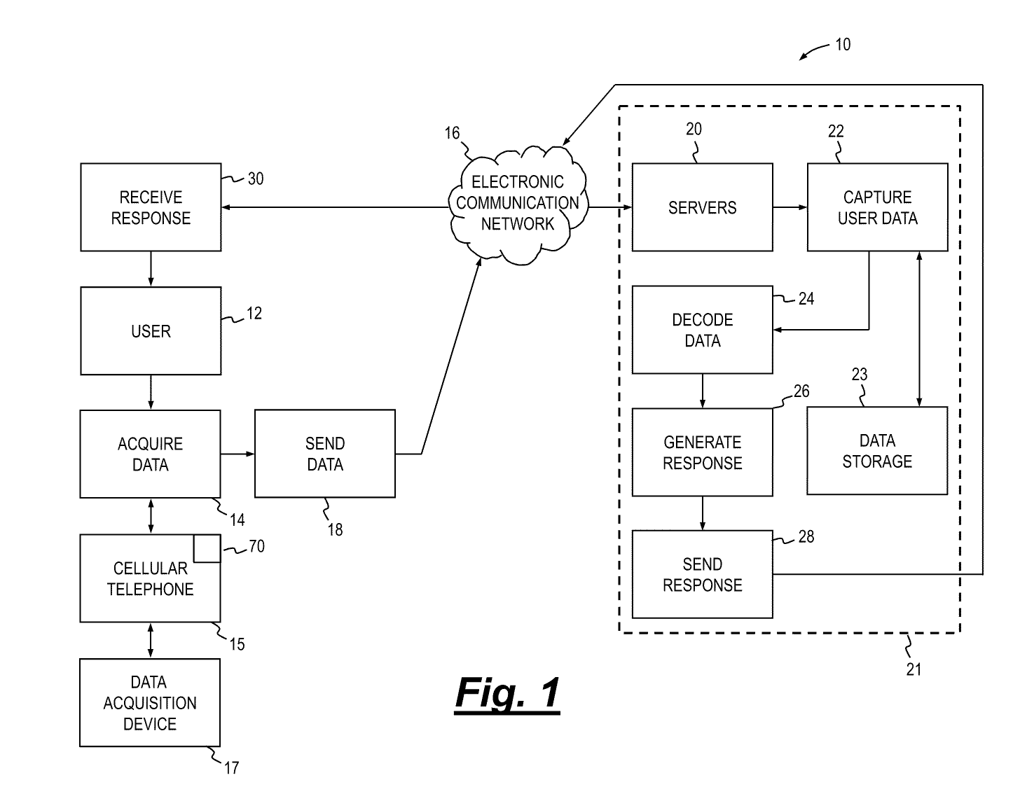

FIG. 1;

FIG. 3 provides details of an embodiment of the system of FIG. 1, relating to an inspirational message system;

FIG. 4 provides details of an embodiment of the system of FIG. 1, relating to a karaoke system;

FIG. 5 provides details of an embodiment of the system of FIG. 1, relating to a MYSPACE social networking system.

FIG. 6 provides details of an embodiment of the system of FIG. 1, relating to a FACEBOOK social networking system;

FIG. 7 provides details of an embodiment of the system of FIG. 1, relating to a TWITTER social networking system;

FIG. 8 provides details of an embodiment of the system of FIG. 1, relating to a language translation system;

FIG. 9 provides details of an embodiment of the system of FIG. 1, relating to a vehicle accident recording and reporting system;

FIG. 10 provides details of an embodiment of the system of FIG. 1, relating to a greeting card message system;

FIG. 11 provides details of an embodiment of the system of FIG. 1, relating to a postage stamp system;

FIG. 12 provides details of an embodiment of the system of FIG. 1, relating to a vehicle tire information system;

FIG. 13 provides details of an embodiment of the system of FIG. 1, relating to a color palette analysis and color matching system;

FIG. 14 provides details of an embodiment of the system of FIG. 1, relating to a text font information and purchasing system;

FIG. 15 provides details of an embodiment of the system of FIG. 1, relating to a cosmetic products information system;

FIG. 16 provides details of an embodiment of the system of FIG. 1, relating to a vehicle parking system;

FIG. 17 provides details of an embodiment of the system of FIG. 1, relating to a restaurant reservation system;

FIG. 18 provides details of an embodiment of the system of FIG. 1, relating to an object information storage and retrieval system;

FIG. 19 provides details of an embodiment of the system of FIG. 1, relating to a vehicle maintenance system; and

FIG. 20 provides details of an embodiment of the system of FIG. 1, relating to a video game enhancement system; and

FIG. 21 provides details of an embodiment of the system of FIG. 1, relating to a physiological data acquisition and telemetry system.

### DETAILED DESCRIPTION

The general arrangement of a system 10 utilizing a cellular telephone 15 having a data acquisition device 17 is shown in FIG. 1 according to an embodiment of the present invention. A user 12 acquires data at 14 with cellular telephone 15 and data acquisition device 17, and utilizes an electronic communication network 16 to transmit, at 18, the acquired data to one or more remote servers 20 maintained by an operator 21 of system 10. The acquired data may include ancillary data, such as satellite-based global positioning (GPS) location data for cellular telephone 15. User 12 data, such as the user's cellular telephone number, name, address, password images or information, user name(s), account information and demographic information provided by the user, may be captured at 22 and stored in a database or data warehouse 23 for later retrieval and use. The received data is decoded at 24 with image-recognition equipment, sensor data analysis equipment, and/or software to generate a corresponding dataset. The dataset is processed at 26 in a predetermined manner to generate a response corresponding to the dataset. At 28 the response is sent to user 12 via network 16. User 12 receives the response at 30 and may utilize the response as desired.

Electronic communication network 16 may comprise a wired or a wireless network, including but not limited to cellular telephone networks. Electronic communication network 16 may additionally include wired or wireless data or computer networks, including intranets and the internet. Electronic communication network 16 may further include voice formats such as voice-over-internet-protocol (VoIP). Electronic communication network 16 may be configured to carry any types or combinations of data and voice formats now known or later invented, including standard and proprietary data and voice formats.

In various embodiments of the present invention user 12 may or may not be required to register at 22. For example, embodiments of system 10 that do not require user 12 data in order to generate an appropriate response at 26 may not require user registration. System 10 may also be utilized by user 12 without registration when system 10 is utilized to provide information and services that are supported by one or more sponsors or include advertising information and thus do not require payment of user fees. Alternatively, user 12 may be incentivized to register by service provider 21 or a sponsor by offering basic information and/or services without registration, with additional features and enhancements being available only to registered users 12. In some embodiments of the present invention user 12 may be required to pay a transactional or subscription fee in addition to providing registration information.

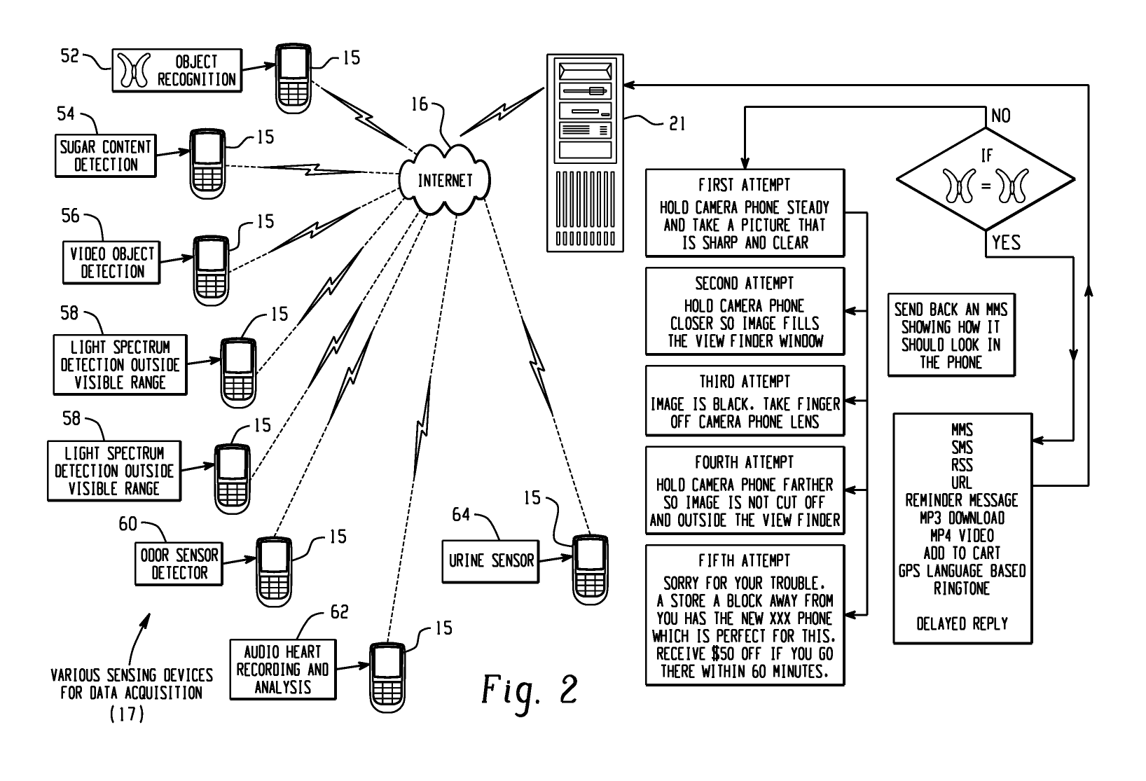

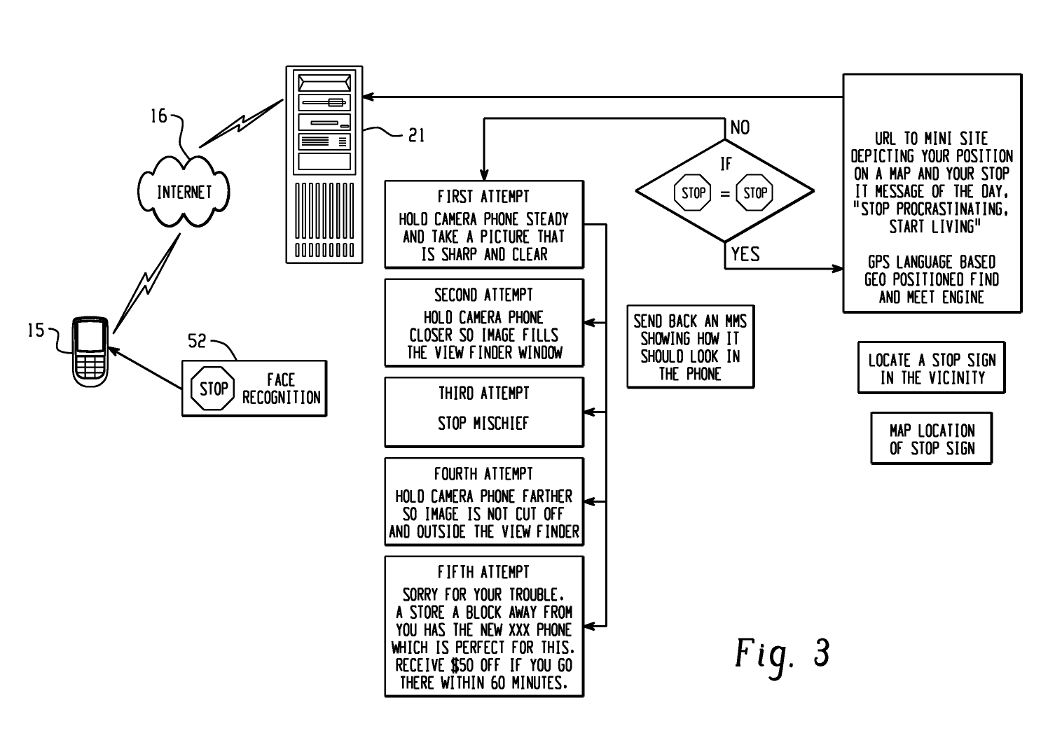

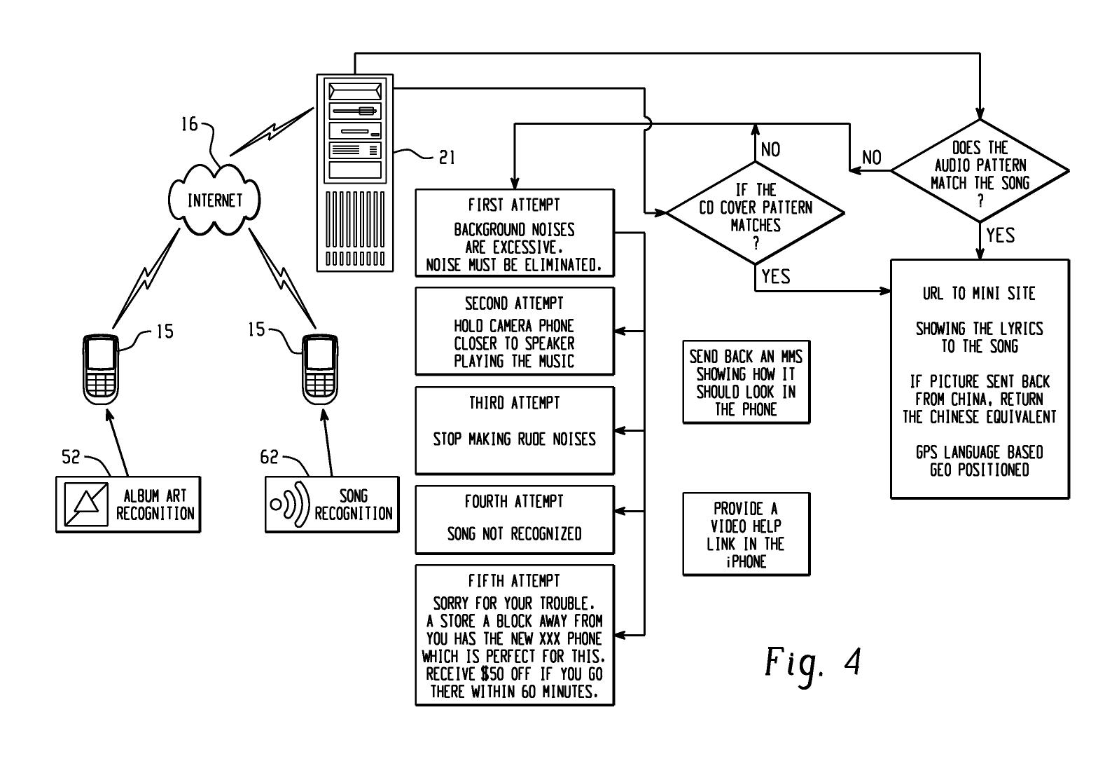

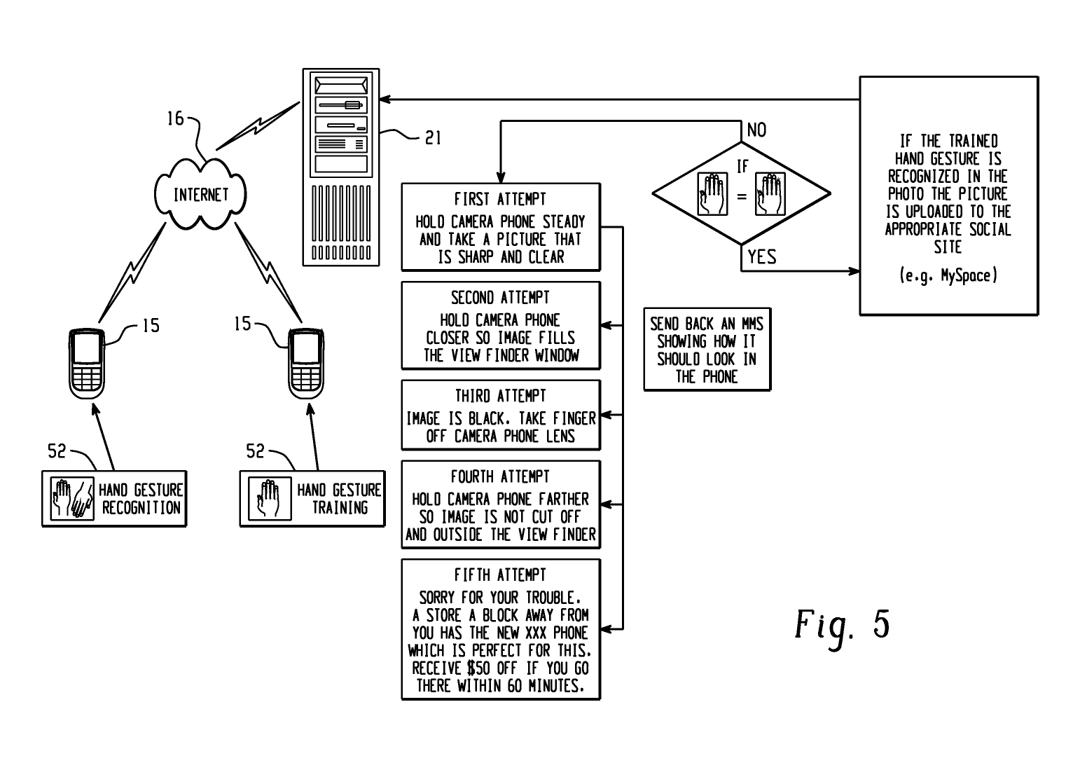

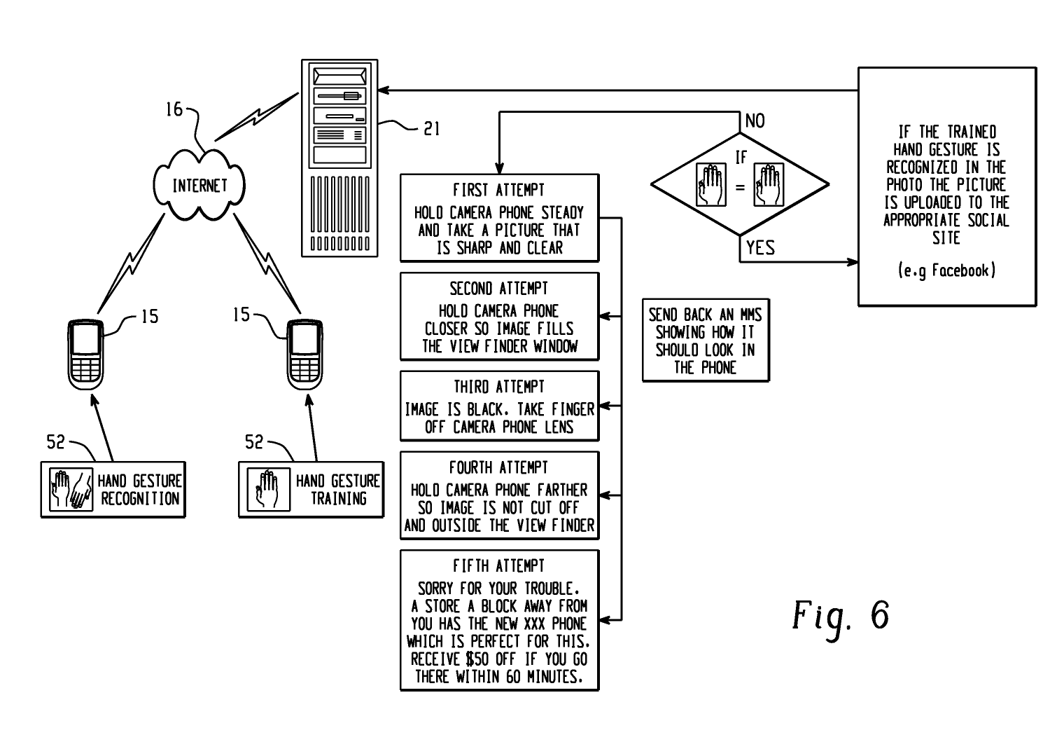

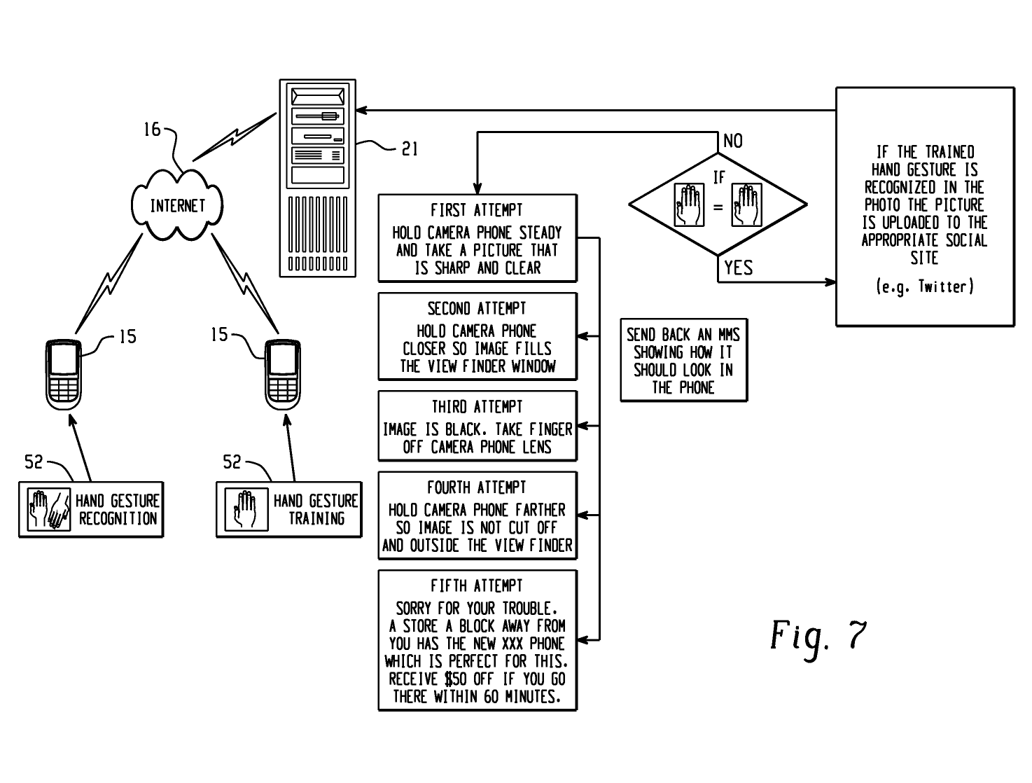

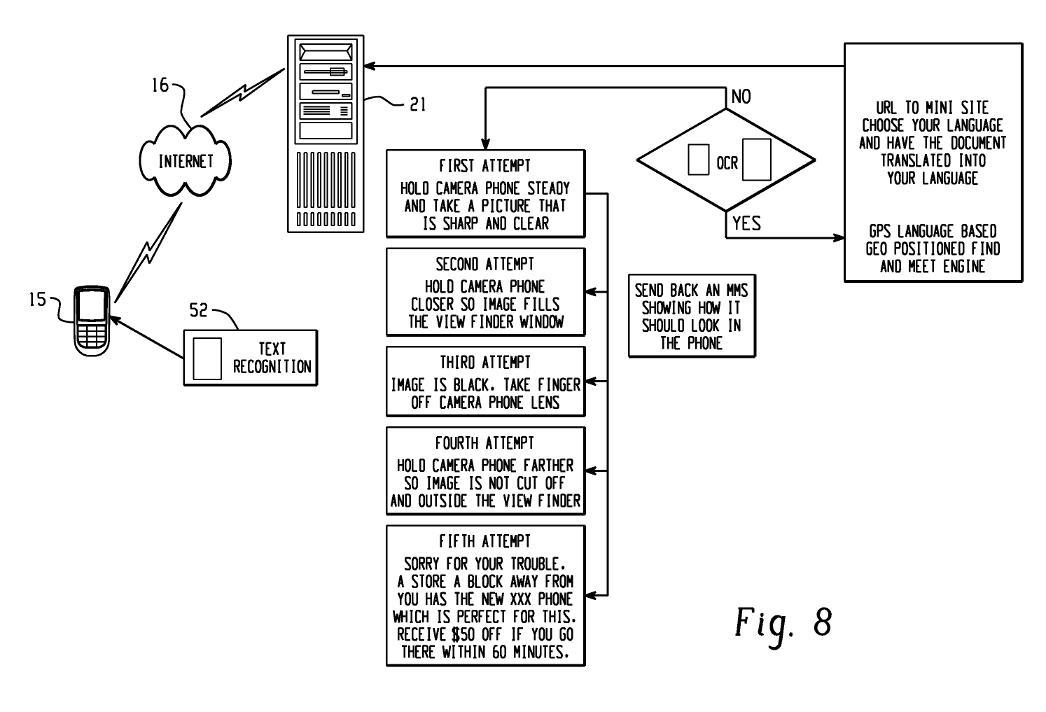

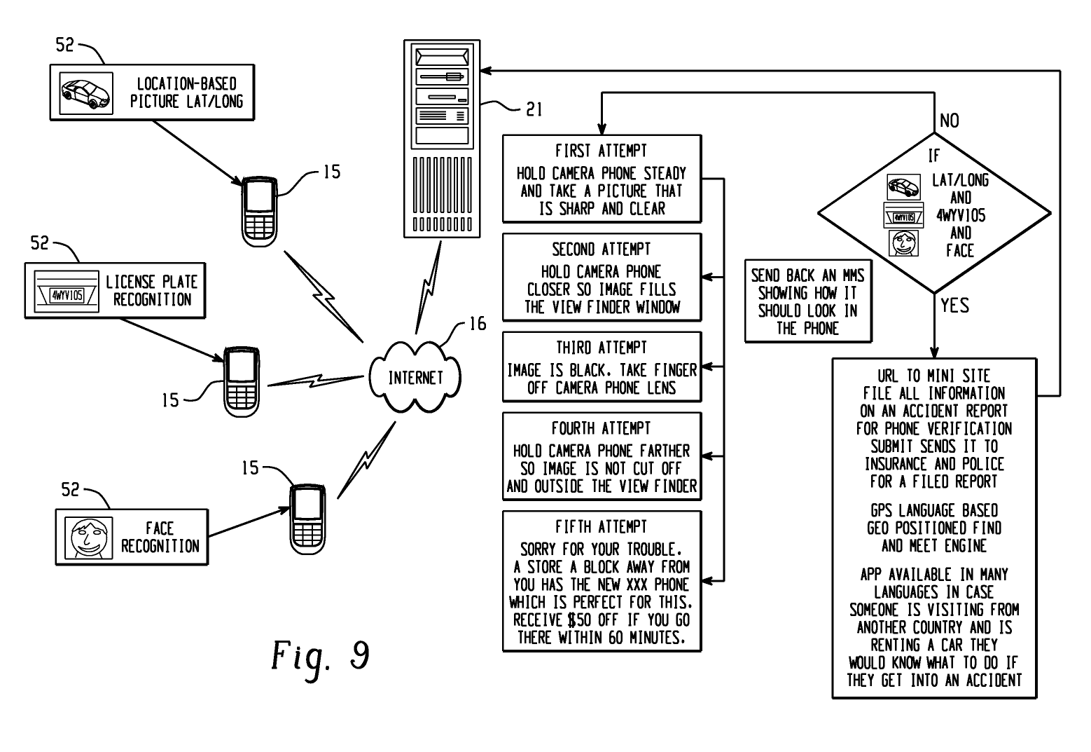

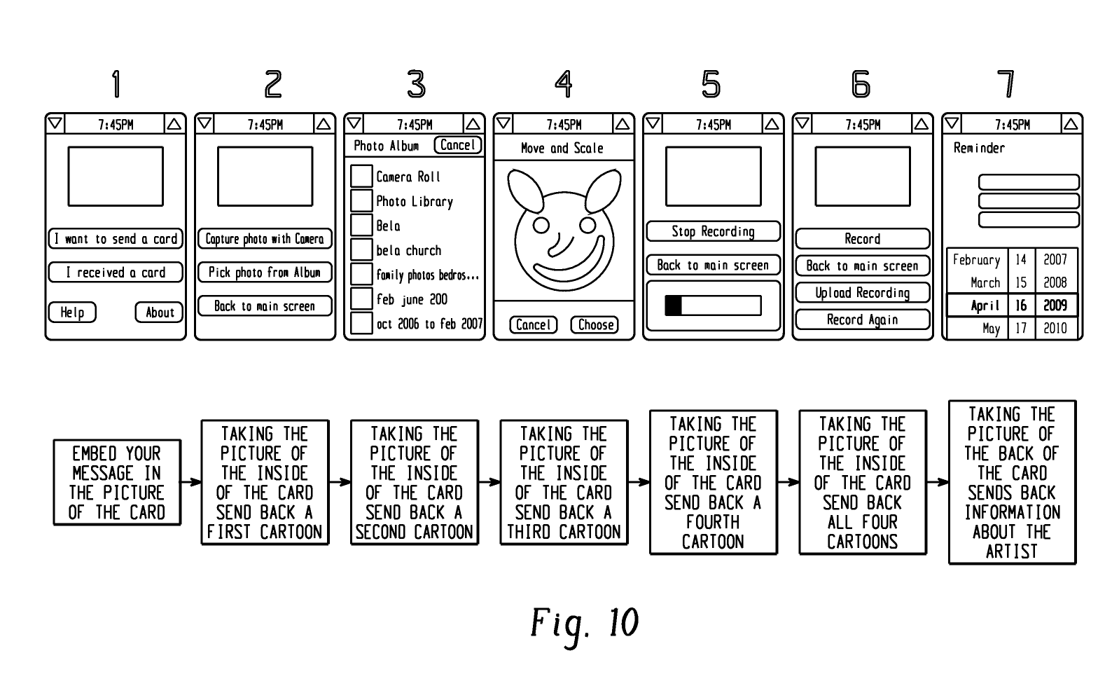

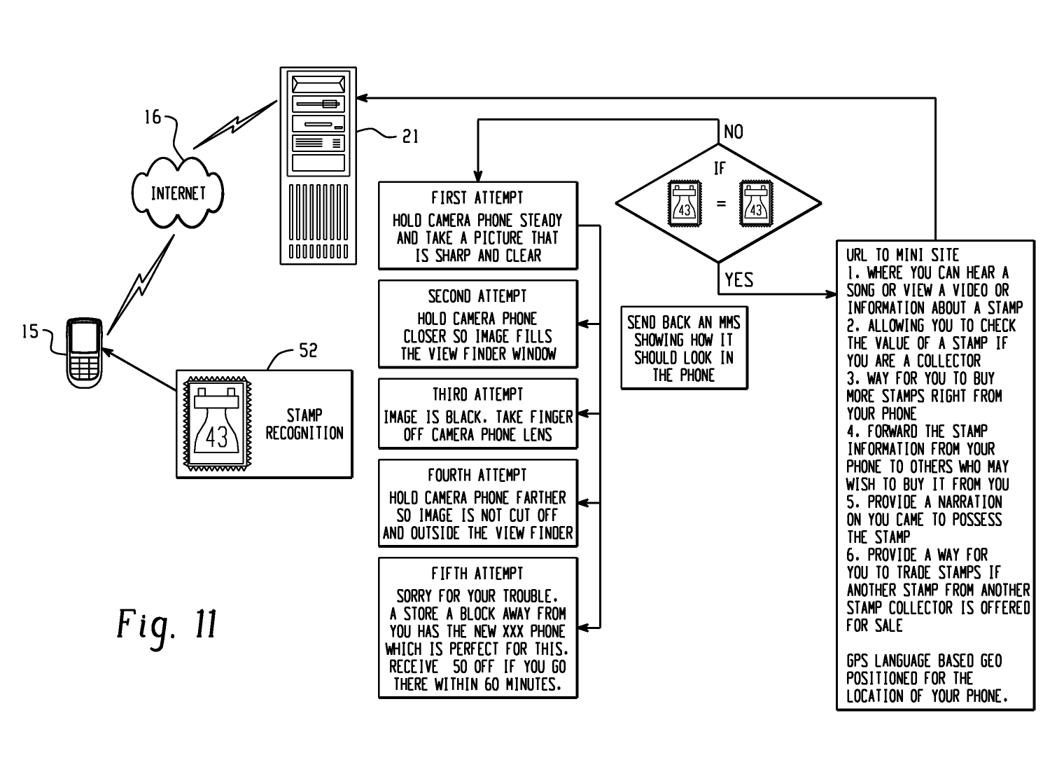

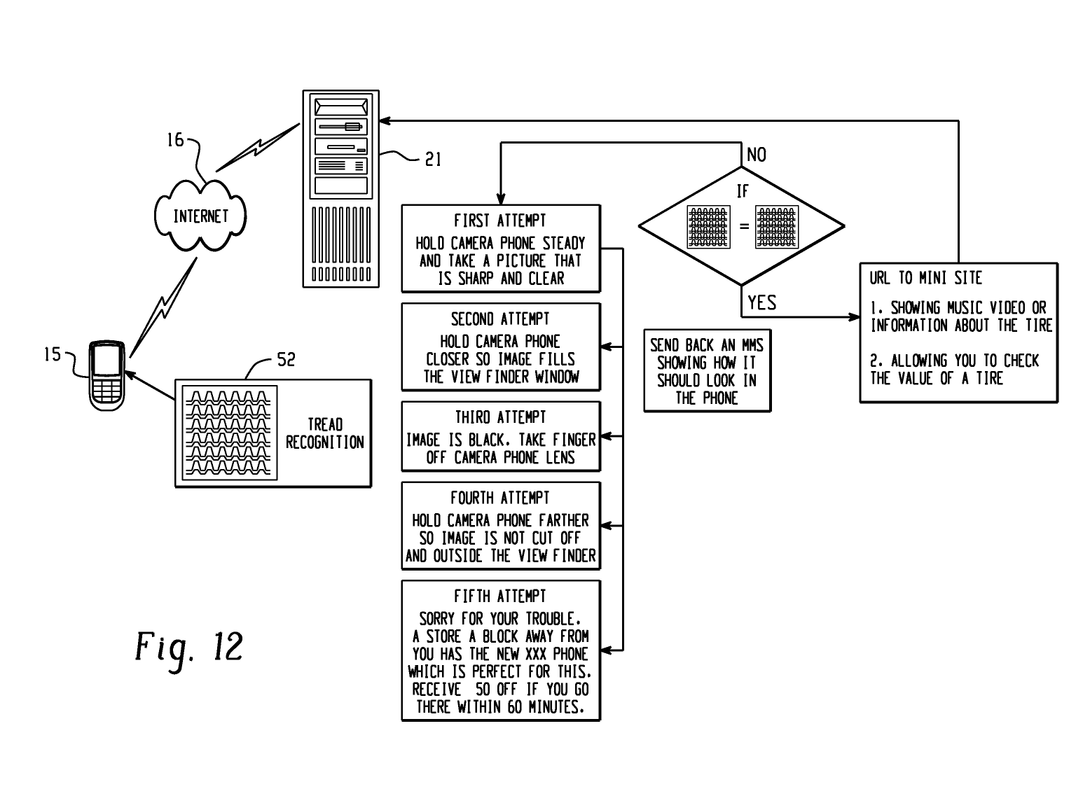

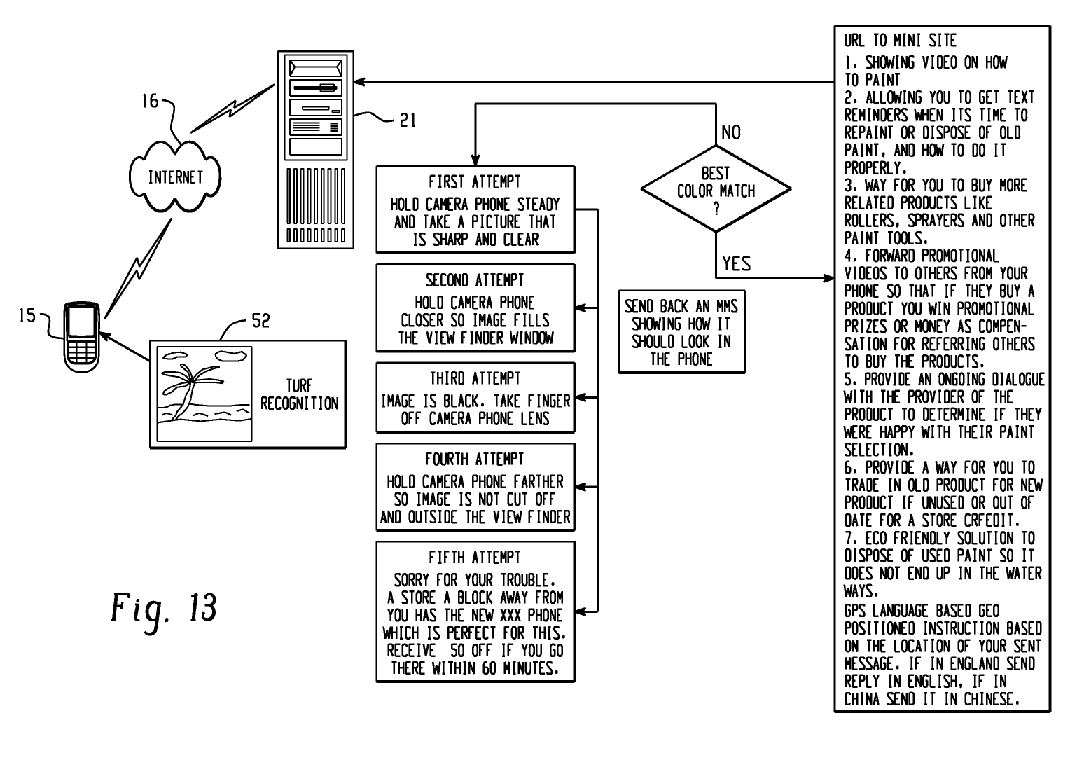

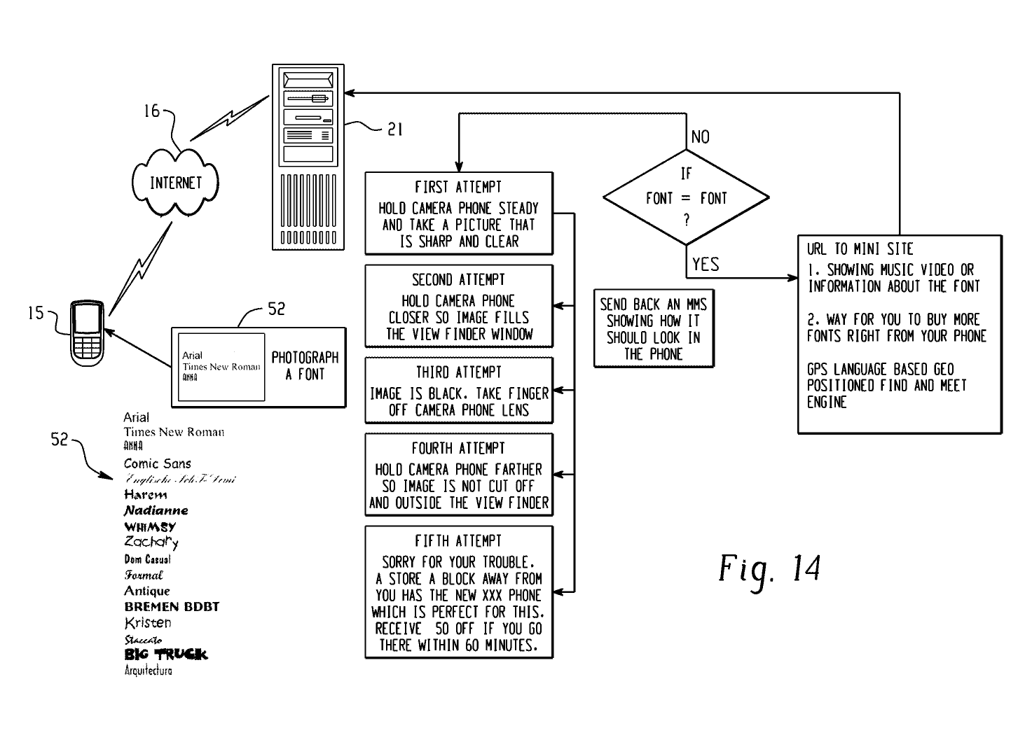

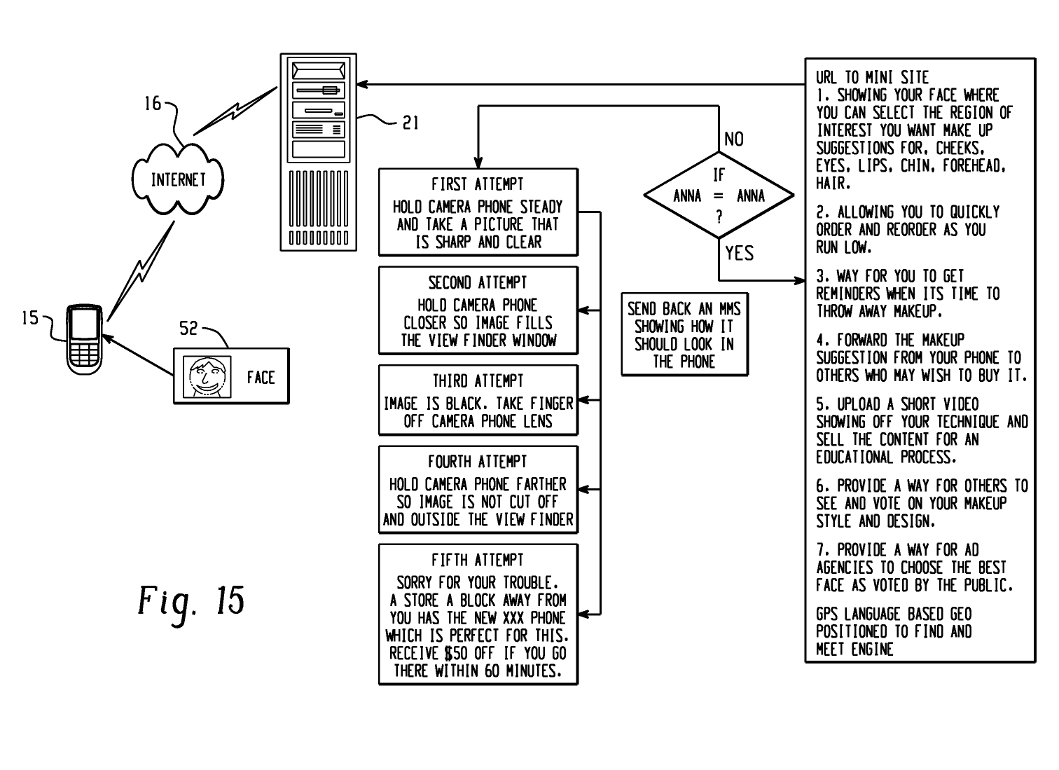

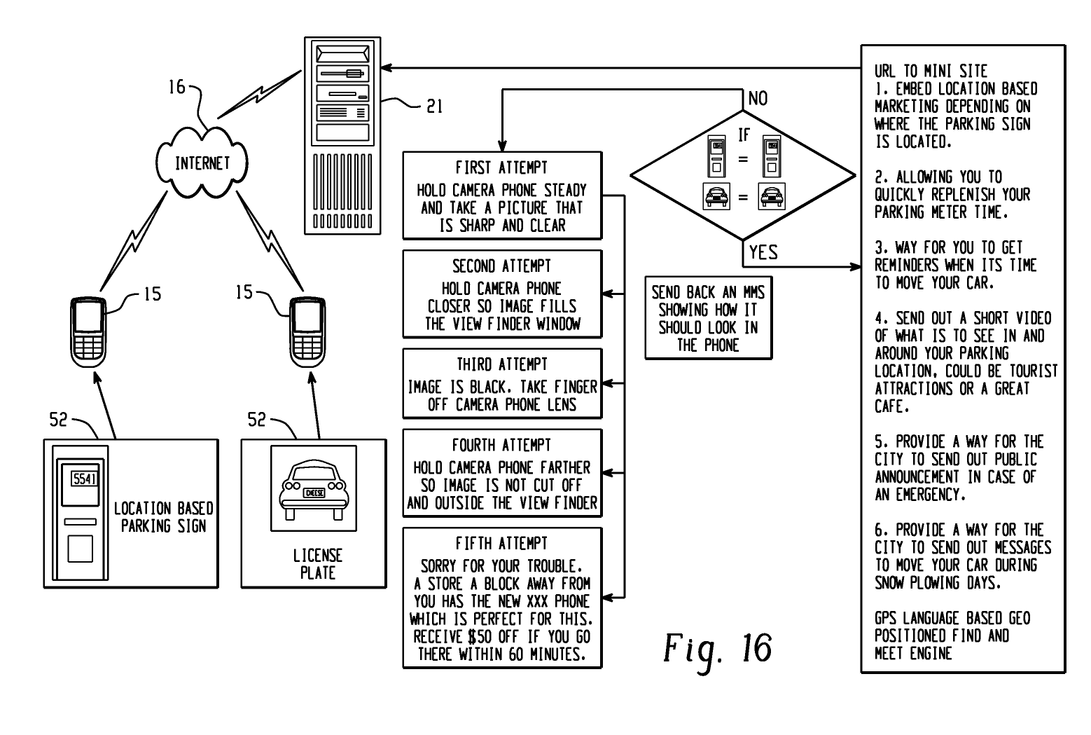

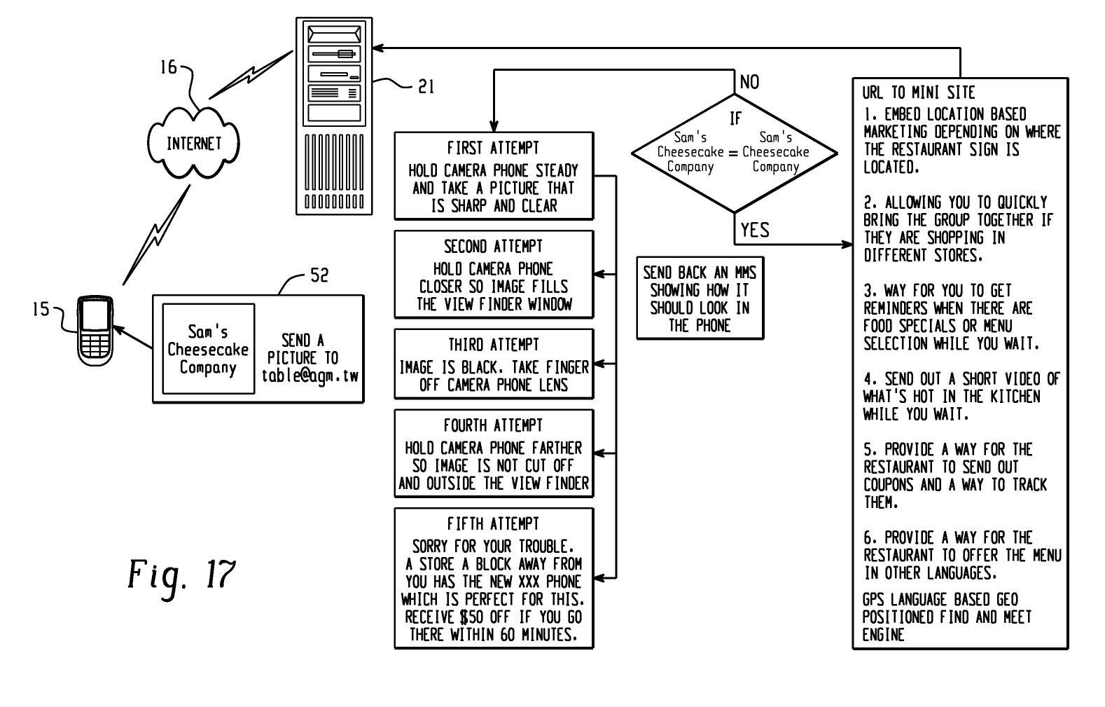

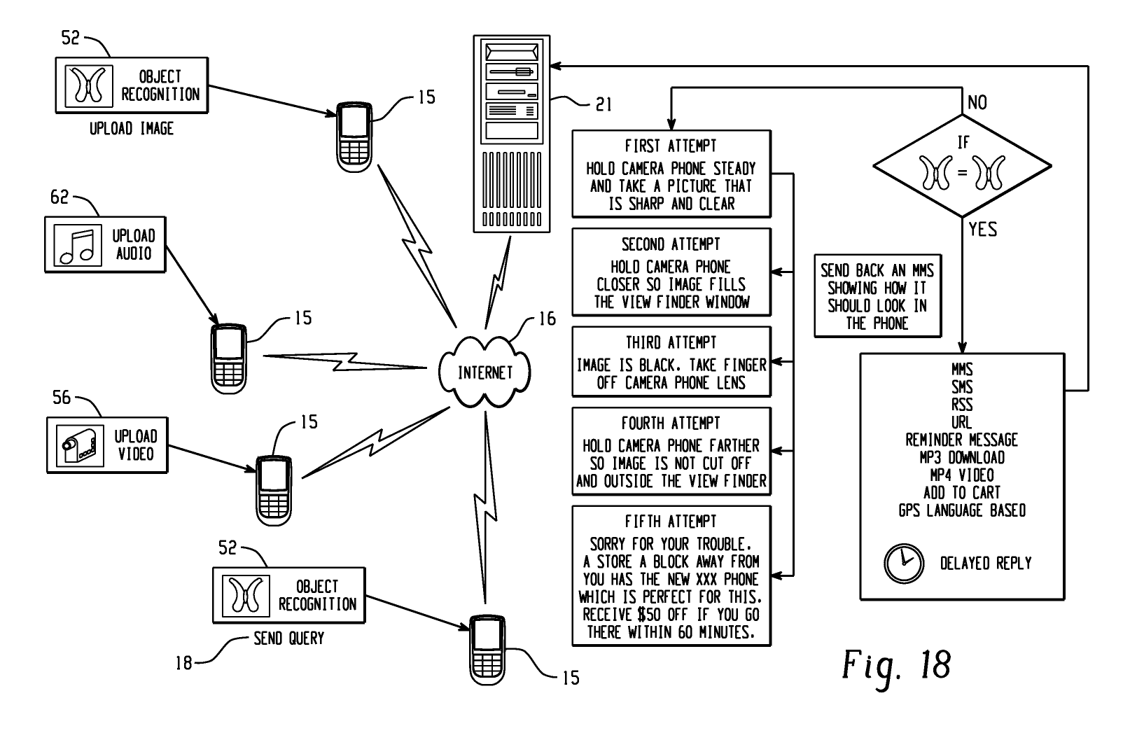

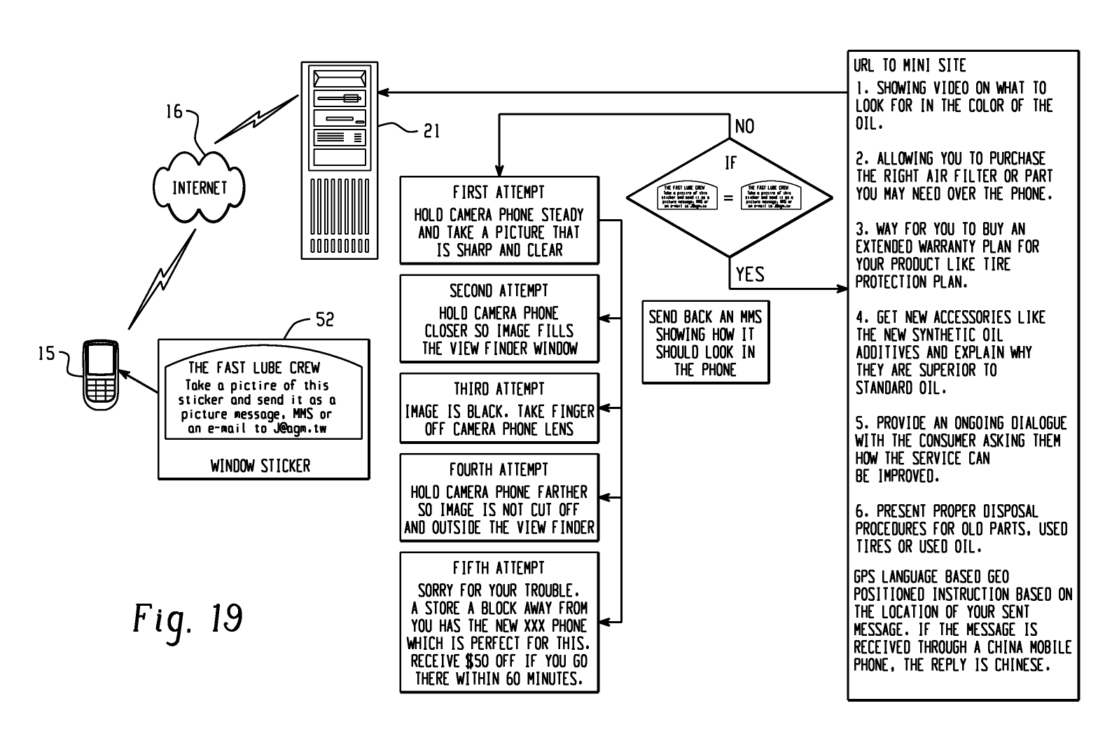

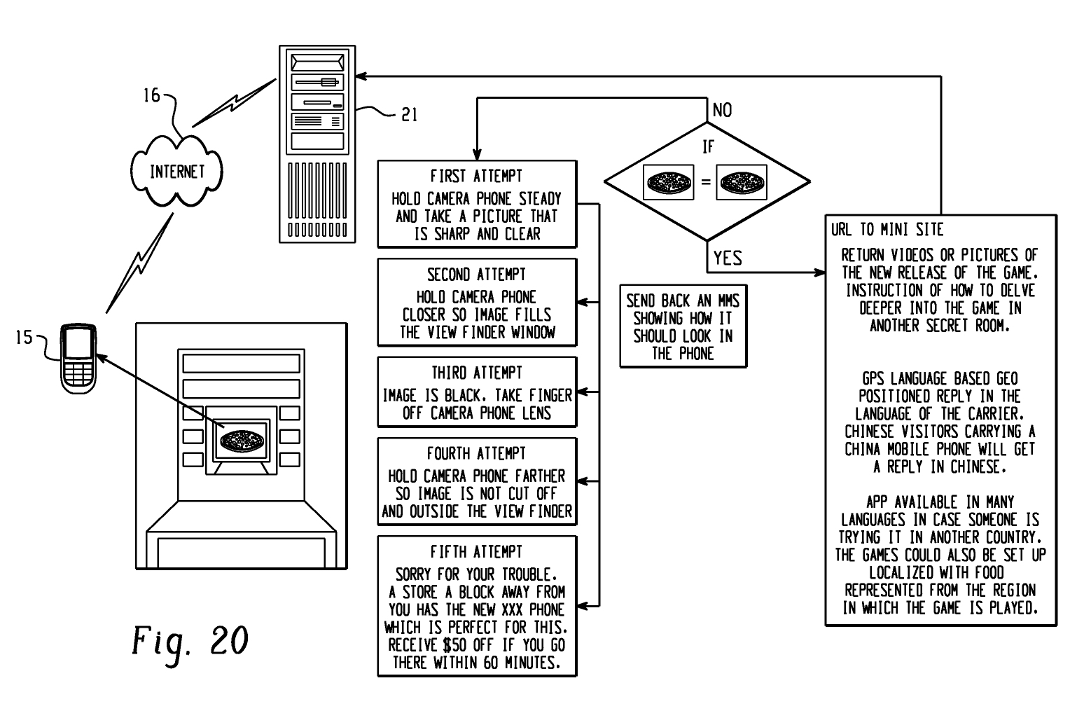

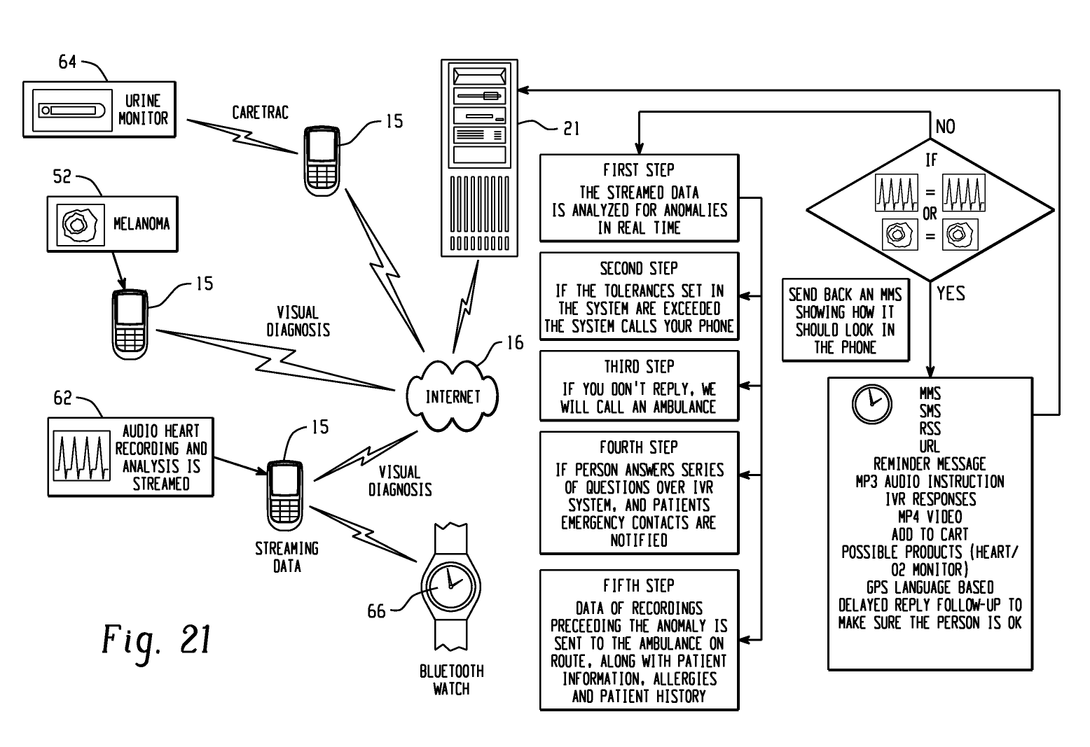

FIG. 2 details various data acquisition devices or “sensors” usable in conjunction with system 10 and a camera-equipped cellular telephone 15. In various embodiments of the present invention these sensing technologies may be integral to cellular telephone 15. Alternatively, the sensors may be incorporated into separate devices and physically or electronically coupled to cellular telephone 15. Further details of the data acquisition devices is provided below.

An object recognition sensor 52 used in conjunction with system 10 captures an image, such as a photographic image, of an object of interest to user 12. Object recognition sensor 52 may record visually perceivable image data, as well as non-visually perceivable image data such as infrared and ultraviolet radiation.

A sugar content sensor 54 may be used in conjunction with system 10 to measure sugar content of foods in any of several ways, such as optically (i.e., utilizing a refractometer). In one embodiment sugar content sensor 54 utilizes sound waves generated by rapping or “thumping” foods such as watermelons to determine the sugar content of the food. In this embodiment, frequency and/or decay characteristics of the sound waves emitted by the thumping action on the foods may be correlated to the sugar content.

A video object sensor 56 is used in conjunction with system 10 to capture a video image of an object of interest to user 12. Video object sensor 56 may record visually perceivable image data, as well as non-visually perceivable image data such as infrared and ultraviolet radiation. In addition, video object sensor 56 may detect movement patterns of the object and/or its environment.

A light spectrum sensor 58 is configured for use in conjunction with system 10 to detect features that are not visually perceivable. Light spectrum sensor 58 may be utilized, for example, to detect visible, infrared and ultraviolet radiation. Light spectrum sensor may also detect predetermined latent patterns in or upon objects.

An odor sensor 60 may be used in conjunction with system 10 for location and measurement and/or quantification purposes. For example, odor sensor 60 may be utilized to detect leakage of industrial substances such as hydrochlorofluorocarbons. Sensor 60 may also be utilized to measure the quality or grade of industrial substances based upon the sensed odor. Sensor 60 may further be used to determine, based upon the sensed odor, whether certain foods such as seafood are spoiled. Sensor 60 may also be used as a physiological sensor, for example, to detect bacteria in a patient's breath for purposes of medical diagnosis.

An audio sensor 62 may be utilized in conjunction with system 10 to detect certain sounds, such as in speech and music recognition. Similarly, audio sensor 62 may be utilized to detect non-speech sounds made by humans, animals and electrical/electronic equipment and machinery for both identifying the sounds and providing information relating to the sounds. Audio sensor 62 may also be used as a physiological sensor, such as for cardiac monitoring and analysis.

A urine sensor 64 may comprise any suitable optical and/or chemical process to detect and/or analyze urine. Urine sensor 64 may be utilized in conjunction with system 10 for legal purposes, such as drug screening. Urine sensor 64 may also be used for medical purposes, such as measuring hydration, glucose levels, and so on in the urine for the purpose of medical diagnosis.

The present invention may be utilized to advantage in a number of ways. The following examples are described for purposes of illustration only and are not intended to be limiting in any way.

### I. Inspirational Message System

With reference to FIGS. 1, 2 and 3, a user 12 may record at 14 an image of a traffic-control sign, such as a STOP sign, with a camera-equipped cellular telephone 15. Ancillary data, such as GPS location data for cellular telephone 15 may also be acquired. User 12 sends the image and any ancillary data to a predetermined service provider 21 via network 16. Service provider 21 comprises elements 20-28 at a known telephone number or network address. The service provider 21 subsequently sends at 28, 30, via network 16, a response 26 to the user 12 containing inspirational message information. In some embodiments the inspirational message includes a tie-in to the text and/or the instructions, warnings or advisories conveyed by the traffic-control sign. In still other embodiments the message may be or include commercial advertising having a tie-in to the text and/or the instructions, warnings or advisories conveyed by the traffic-control sign. In yet other embodiments user 12 may register as a contestant at 22 by supplying predetermined information such as name, physical address, email address telephone number, demographic information, etc. Thereafter, user 12 may transmit to service provider 21, using system 10, images of traffic-control signs of a specified type or quantity, or from one or more specified locations, to earn or compete for prizes. The information sent by service provider 21 may be received by user 12 at 30 and may displayed on the user's cellular telephone 15.

### II. Karaoke System

With reference to FIGS. 1, 2 and 4, a user 12 may request or select a desired karaoke song using a camera-equipped cellular telephone 15. The request may be made by capturing an image relating to the song, such as an album cover or a poster, recording an audio snippet of the song, or keying in the song's title and/or artist. The user 12 sends the request, via network 16, to a predetermined service provider 21 comprising elements 20-28 at a known telephone number or network address. The service provider 21 subsequently sends at 28, 30, via network 16, a response 26 to the user 12 containing information relating to the requested song. The information may include, without limitation, a download of the song in its entirety, a download of the song with one or more vocal tracks removed, “sheet” music for the song, and karaoke-style movable text for display on the cellular telephone 15.

### III. MYSPACE Social Networking Utility

With reference to FIGS. 1, 2 and 5, a user 12 may record at 14 an image to be added to the user's MYSPACE social networking account with a camera-equipped cellular telephone 15. User 12 sends the image, via network 16, to a predetermined service provider 21 comprising elements 20-28 at a known telephone number or network address. The image may include predetermined criteria, such as a hand gesture, which may be read and interpreted by service provider 21 as a password, command, etc. by the service provider by decoding the image at 24. The service provider 21 subsequently updates the user's MYSPACE account with the image provided by user 12 at 18.

### IV. FACEBOOK Social Networking Utility

With reference to FIGS. 1, 2 and 6, a user 12 may record at 14 an image to be added to the user's FACEBOOK social networking account with a camera-equipped cellular telephone 15. User 12 sends the image, via network 16, to a predetermined service provider 21 comprising elements 20-28 at a known telephone number or network address. The image may include predetermined criteria, such as a hand gesture, which may be read and interpreted by service provider 21 as a password, command, etc. by the service provider by decoding the image at 24. The service provider 21 subsequently updates the user's FACEBOOK account with the image provided by user 12 at 18.

### V. TWITTER Social Networking Utility

With reference to FIGS. 1, 2 and 7, a user 12 may record at 14 an image to be added to the user's TWITTER social networking account with a camera-equipped cellular telephone 15. User 12 sends the image, via network 16, to a predetermined service provider 21 comprising elements 20-28 at a known telephone number or network address. The image may include predetermined criteria, such as a hand gesture, which may be read and interpreted by service provider 21 as a password, command, etc. by the service provider by decoding the image at 24. The service provider 21 subsequently updates the user's TWITTER account with the image provided by user 12 at 18.

### VI. Translation Utility

With reference to FIGS. 1, 2 and 8, a user 12 captures an image of text to be translated with a camera-equipped cellular telephone 15 and sends the image, via network 16, to a predetermined service provider 21 comprising elements 20-28 at a known telephone number or network address. User 12 also supplies service provider 21 with a desired translation language. The service provider 21 subsequently sends at 28, 30, via network 16, a response 26 to the user 12 containing information relating to the translation. The information may include a translation of the text, in the select language, for display on the cellular telephone. In some embodiments a registered user 12 may pre-select a default select translation language. In still other embodiments user 12 may provide an audio recording to service provider 21 via network 16, the service providing subsequently sending an aural and/or textual translation of the audio recording.

### VII. Accident Insurance Reporting Utility

With reference to FIGS. 1, 2 and 9, a registered user 12 may record at 14 an image of damage to a vehicle with a camera-equipped cellular telephone 15. Ancillary data, such as satellite-based GPS location data for cellular telephone 15 and detailed information regarding the accident may also be acquired. User 12 sends the image and any ancillary data via network 16 to a predetermined service provider 21 comprising elements 20-28 at a known telephone number or network address. The service provider subsequently sends at 28, via network 16, a response 26 containing information such as the photographic image, ancillary accident information and user 12 information to the insurance provider on behalf of the user for the purpose of filing an insurance claim. Service provider 21 may similarly provide the information to law enforcement personnel for the purpose of compiling an accident report. A response 26 sent to user 12 at 30 may include instructions for dealing with the accident, personnel to be contacted, and so on.

### VIII. Greeting Card Utility

With reference to FIGS. 1, 2 and 10, a user 12 purchases a greeting card and an instructional insert. Using a cellular telephone 15 user 12 records a personal message, which may be any or all of a video, a photograph or a voice message. User 12 sends the message, via network 16, to a predetermined service provider 21 comprising elements 20-28 at a known telephone number or network address. User 12 gives the card and the instructional insert to a desired recipient. The recipient follows the instructions on the instructional insert and sends an image of a predetermined portion of the greeting card to the service provider 21 via network 16. The service provider 21 subsequently sends to the recipient at 28, 30, via network 16, a response 26 containing the personal message provided to the service provider by user 12. The service provider may also send the recipient ancillary information relating to the greeting card, such as video and still images, information about the artist, and so on. In some embodiments the instructional information may be integral to the greeting card rather than an insert.

### IX. Postage Stamp Information

With reference to FIGS. 1, 2 and 11, a user 12 may record at 14 an image of a postage stamp with a camera-equipped cellular telephone 15 and send the image, via network 16, to a predetermined service provider 21 comprising elements 20-28 at a known telephone number or network address. The service provider 21 subsequently sends at 28, 30, via network 16, a response 26 to the user 12 containing information relating to the postage stamp. The response 26 may include information about the stamp such as its denomination, the subject portrayed on the stamp, the artist, songs, videos, and so on. The information may further include information relating to ordering stamps. The system is usable both for current-issue and collectible postage stamps.

### X. Tire Information

With reference to FIGS. 1, 2 and 12, a user 12 may record at 14 an image of a tire tread with a camera-equipped cellular telephone 15 and send the image, via network 16, to a predetermined service provider 21 comprising elements 20-28 at a known telephone number or network address. The service provider 21 subsequently sends at 28, 30 via network 16, a response 26 to the user 12 containing information relating to the tire. The information may include, without limitation the make, model and type of tire, promotional and technical information relating to the tire, and information relating to vendors for the tire. Current users of the tires may receive service reminders for maintenance such as rotating the tires. Ordering information for custom tires, such as custom names and logos on the tires, may also be provided.

### XI. Color Palette Analysis

With reference to FIGS. 1, 2 and 13, a user 12 may record at 14 an image of an object of interest with a camera-equipped cellular telephone 15 and send the image, via network 16, to a predetermined service provider 21 comprising elements 20-28 at a known telephone number or network. The service provider 21 subsequently sends at 28, 30, via network 16, a response 26 to the user 12 containing information relating to the object. The information may include, without limitation, the colors that comprise the object, where to buy paint in those colors, where the paint is located in a vendor's store, and matching and complementary colors. Calculations regarding the amount of paint required for a given living space, etc. may also be made by scaling an object of known size in the image and providing or calculating additional information about the space to be painted, such as the distance between walls.

### XII. Font Acquisition System

With reference to FIGS. 1, 2 and 14, a user 12 captures an image of a font of interest with a camera-equipped cellular telephone 15 and sends the image, via network 16, to a predetermined service provider 21 comprising elements 20-28 at a known telephone number or network address. The service provider 21 subsequently sends at 28, 30, via network 16, a response 26 to the user 12 containing information relating to the fonts. The information may include, for example, the names of the fonts, where the fonts are used, historical information relating to the fonts, and instructions for purchasing the fonts for use in electronic devices such as cellular telephones and computers. In some embodiments registered users may forward fonts, be alerted when the user's friends and associates use the fonts, recommend fonts, and make and receive referrals relating to the fonts.

### XIII. Cosmetic Application System

With reference to FIGS. 1, 2 and 15, a user 12 records an image of a face of a human with a camera-equipped cellular telephone 15 and sends the image, via network 16, to a predetermined service provider 21 comprising elements 20-28 at a known telephone number or network address. The service provider 21 subsequently sends at 28, 30, via network 16, a response 26 to the user 12 containing information relating to cosmetics for the subject face. The information may include, for example, optimal brands and types of makeup, blush, eye shadow and lipstick, along with information on how and where to purchase the cosmetics. Response 26 may further include expiration reminders for cosmetics. System 10 may be further adapted to accommodate voting by other users of images showing user 12 wearing various cosmetics, as well as competitions among users relating to the cosmetics.

### XIV. Vehicle Parking Payment System

With reference to FIGS. 1, 2 and 16, a user 12 captures an image of a location-based parking sign and/or a vehicle license plate with a camera-equipped cellular telephone. Ancillary data, such as satellite-based GPS location data for cellular telephone 15 may also be acquired. User 12 sends the image and any ancillary data to a predetermined service provider 21 via network 16. Service provider comprises elements 20-28 at a known telephone number or network address. The service provider 21 bills a predetermined user 12 account for the vehicle parking charges. The service provider may also send at 28, 30, via network 16, a response to the user 12 containing information relating to the amount billed and the expiration time. In addition, service provider 21 may send user 12 at 28, 30, via network 16, a response 26 containing a reminder message when the parking time is about to expire.

### XV. Restaurant Reservation System

With reference to FIGS. 1, 2 and 17, a user 12 captures an image of a restaurant sign, menu, etc. with a camera-equipped cellular telephone 15 and sends the image, via network 16, to a predetermined service provider 21 comprising elements 20-28 at a known telephone number or network address. The service provider at 28, 30, confirms the reservation to user 12 via network 16 and then sends a text or email message to the user via the network when the table becomes available. In some embodiments user 12 provides service provider 21 with ancillary information such as the number of patrons in the reservation and the location of the restaurant. In still other embodiments system 10 determines the location of the restaurant using GPS data from the cellular telephone used by user 12 or information about the restaurant found in the image sent to service provider 21 by user 12.

### XVI. Object Database System

With reference to FIGS. 1, 2 and 18, a user 12 captures an image of an object of interest with a camera-equipped cellular telephone and sends the image, via network 16, to a predetermined service provider 21 comprising elements 20-28 at a known telephone number or network address. The service provider 21 responds to user 12 with information relating to a network location available to the user to supply information about the object of interest, such as size, color, weight, price, “SKU” code, features and so on. Subsequent users who send the service provider 21 an image matching the object of interest will receive from the service provider the information provided by user 12. In some embodiments of the present invention the information provided by user 12 may be edited and/or augmented by subsequent users. In other embodiments the information is “locked” and can be edited or augmented only by user 12.

### XVII. Service Reminder with Coupon

With reference to FIGS. 1, 2 and 19, a user 12 captures an image of a service reminder, such as an oil change service label located on a vehicle windshield, and sends the image, via network 16, to a predetermined service provider 21 comprising elements 20-28 at a known telephone number or network address. The service provider 21 subsequently sends at 28, 30, via network 16, a response 26 to the user 12 containing information relating to servicing the vehicle to which the label is attached. The information may include, without limitation, oil change reminders, periodic service reminders, miles-based service intervals, and so on. The service provider 21 may also send user 12 discount coupons for vehicle service or referrals to nearby vendors.

### XVIII. Electronic Game Commerce System

With reference to FIGS. 1, 2 and 20, a user 12 playing a video electronic game on a computer or a video screen captures an image appearing on the game video and sends the image to a predetermined service provider 21 via network 16. Service provider 21 comprises elements 20-28 at a known telephone number or network address. The service provider 21 subsequently sends at 28, 30, via network 16, a response 26 to the user 12 containing information relating to various incentives such as chances to win prizes, game clues, enhanced game options, new releases of the game, game “cheat codes,” instructions for purchasing or winning merchandise and food, and so on.

### XIX. Telemetry System

With reference to FIGS. 1, 2 and 21, sensors such as object recognition 52, light spectrum detection 58, odor sensor 60, audio sensor 62 and urine sensor 64 may be utilized to gather physiological data relating to a user 12. Ancillary data, such as satellite-based GPS location data for cellular telephone 15 may also be acquired. The physiological data and any ancillary data may be transmitted via network 16 to a predetermined service provider 21 comprising elements 20-28 at a known telephone number or network address. If an anomaly in the physiological data is detected the service provider 21 subsequently sends at 28, 30, via network 16, a response 26 to the user 12 containing information relating to the anomaly. If the anomaly is life-critical the service provider may attempt to contact user 12 and, if no contact is made, request emergency medical services for the user. In some embodiments a Bluetooth communications device 66 may be utilized to transfer physiological and ancillary data from user 12 to service provider via network 16, and to transfer a response 26 from the service provider to the user at 28, 30 via the network.

### XX. System Function Key

With reference to FIG. 1, cellular telephone 15 may be configured to include a function button key 70 to operate system 10 without the need for user 12 to perform the previously detailed discrete steps. Instead, user 12 may simply direct cellular telephone 15 at an object of interest and press the function key to receive a response at 30.

### XXI. Medical Information System

“vCard” is a file format standard for electronic business cards. vCards are often attached to e-mail messages, but can be exchanged in other ways, such as on the internet or instant messaging. vCards may contain name and address information, phone numbers, e-mail addresses, URLs, logos, photographs, and even audio clips. In one embodiment of the present invention a user 12 may present a standardized-format electronic file to a medical practitioner in lieu of a paper form, the file containing information such as, but not limited to, personal information, insurance information, medical information and a medical history for user 12.

### XXII. Electronic Commerce System

An electronic commerce system may be utilized in conjunction with system 10. With reference to FIG. 1, a user 12 includes checking account or bank card (e.g., credit card or debit card) information when registering at 22. The registration may include an image or a set of images sent from user 12 to service provider 21. Service provider 21 returns the images to user 12, who adds titles to the images and provides the titles to the service provider. The titled images become a kind of watermark authentication to confirm the identity of user 12. When making a purchase, service provider 21 sends user 12 a random image from the set of images on file. User 12 replies with the title for the image in order to confirm the user's identity.

In an enhanced embodiment service provider 21 sends user 12 a tumbler pin code to telephone 15 as a text message which the user must provide to the service provider at the time of checking out. The pin code is only good for a limited amount of time, after which it expires. This validates to service provider 21 that user 12 is actually in possession of the telephone 15 at the time of ordering.

In yet a further enhancement, user 12 information provided at registration may include biometric data, such as the user's face. In this manner service provider 21 can confirm the identity of user 12 based on the biometric data, the identification of an image in the manner described above, and the user's possession of the registered telephone 15.

This electronic commerce system provides a secure process for making purchases using both feature phones and smart phones without the need to send credit card information over an unsecured network 16.

If user 12 meets all of the aforementioned security criteria service provider 21 completes the transaction and debits the user's checking account or bank card.

### XXIII. Wildlife Identification System

With reference to FIG. 1, a user records sounds of birds using telephone 15 and audio sensor 64 and sends the recording to a predetermined service provider 21 via network 16. Service provider 21 comprises elements 20-28 at a known telephone number or network address. The service provider 21 subsequently sends at 28, 30, via network 16, a response 26 to the user 12 containing information relating to the recording. The information may include, without limitation, information about the types of birds found in the recording and recommended food for the birds.

### XXIV. Real Estate Gardening System

With reference to FIG. 1, a user utilizes the GPS function of telephone 15, moving about a select parcel of real estate to generate an estimate of the area or size of the real estate. User 12 sends the GPS data to a predetermined service provider 21 via network 16. Service provider 21 comprises elements 20-28 at a known telephone number or network address. The service provider 21 subsequently sends at 28, 30, via network 16, a response 26 to the user 12 containing information relating to the real estate. The information may include, without limitation, information about the amount of grass seed and/or fertilizer necessary for planting on the select real estate.

### XXV. Indoor Lighting Analysis System

With reference to FIG. 1, a user utilizes telephone 15 to capture images of the lighting with sensor 58 and/or images of plants with object sensor 52. User 12 sends the images to a predetermined service provider 21 via network 16. Service provider 21 comprises elements 20-28 at a known telephone number or network address. The service provider 21 subsequently sends at 28, 30, via network 16, a response 26 to the user 12 containing information relating to the light and/or plants. The information may include, without limitation, information about kind of light bulbs needed for optimal plant growth indoors.

### XXVI. Celebrity Voting and Information System

With reference to FIG. 1, a user utilizes telephone 15 to capture an image of a celebrity, such as a competitor on a reality or game show, an entertainer, a politician, a historical figure, and so on. At 18 user 12 sends the image to a predetermined service provider 21 via network 16. Service provider 21 comprises elements 20-28 at a known telephone number or network address. The service provider 21 subsequently sends at 28, 30, via network 16, a response 26 to the user 12 containing information relating to the celebrity. The information may include, without limitation, information about the celebrity. In some embodiments the sending of the image at 18 constitutes a vote for the celebrity recorded in the image, the response at 30 being a confirmation of the vote.

### Conclusion

With regard to system 10, it should be noted that the system may be utilized world-wide. Consequently, data sent at 18 of FIG. 1 may be in widely varied user 12 languages. In some embodiments of the present invention the language of the information in response 26 may be matched to the language of the request at 18. Alternatively, the language of the information in response 26 may be in any language requested by user 12.

While this invention has been shown and described with respect to a detailed embodiment thereof, it will be understood by those skilled in the art that changes in form and detail thereof may be made without departing from the scope of the claims of the invention.

What is claimed is:

1. A system for exchanging information, comprising:
at least one cellular telephone having a data acquisition device, a receiver and a transmitter;
an electronic communication network to receive acquired data transmitted by the cellular telephone and to re-transmit the acquired data to at least one remote server;
a data decoding device accessible to the remote server, the data decoding device decoding the acquired data and generating a corresponding dataset; and
a processor accessible to the remote server to generate a response corresponding to the dataset, the response being forwarded from the remote server to the receiver of the cellular telephone by means of the electronic communication network.

2. The system of claim 1, further including a database accessible to the remote server, the database storing acquired data transmitted from the cellular telephone for later retrieval.

3. A method for exchanging information, comprising the steps of:
acquiring data with a camera-equipped cellular telephone;
utilizing an electronic communication network to transmit the acquired data to at least one remote server;
decoding the acquired data at the remote server to generate a corresponding dataset;
processing the dataset at the remote server in a predetermined manner to generate a response corresponding to the dataset; and
sending the response from the remote server to the cellular telephone by means of the electronic communication network.

4. The method of claim 3, further including the steps of:
providing a database accessible to the remote server;
transmitting, utilizing the electronic communication network, data from the cellular telephone to the remote server; and
storing the data in the database.

5. The method of claim 3 wherein the data relates to a traffic-control sign; and
wherein the response comprises information relating to an inspirational message.

6. The method of claim 3 wherein the data relates to a song; and
wherein the response comprises information relating to at least one of music and lyrics relating to the song.

7. The method of claim 3 wherein the data relates to a social network; and
wherein the response comprises information relating to a subscriber to the social network.

8. The method of claim 3 wherein the data relates to a text in a first language; and
wherein the response comprises a translation of the text in a second, select language.

9. The method of claim 3 wherein the data relates to damage to a vehicle; and
wherein the response comprises information relating to an insurance claim for the vehicle.

10. The method of claim 3 wherein the data relates to a greeting card; and
wherein the response comprises information relating to a personal message associated with the greeting card.

11. The method of claim 3 wherein the data relates to a postage stamp; and
wherein the response comprises information relating to the postage stamp.

12. The method of claim 3 wherein the data relates to a vehicle tire; and
wherein the response comprises information relating to the vehicle tire.

13. The method of claim 3 wherein the data relates to the color of an object; and
wherein the response comprises information relating to the color of the object.

14. The method of claim 3 wherein the data relates to a text font; and
wherein the response comprises information relating to the text font.

15. The method of claim 3 wherein the data relates to facial features of a human; and
wherein the response comprises information relating to cosmetics compatible with the facial features of the human.

16. The method of claim 3 wherein the data relates to a vehicle parking space; and
wherein the response comprises information relating to the vehicle parking space.

17. The method of claim 3 wherein the data relates to a restaurant reservation; and
wherein the response comprises information relating to the restaurant reservation.

18. The method of claim 3 wherein the data relates to a select object; and
wherein the response comprises information relating to the select object.

19. The method of claim 3 wherein the data relates to a service reminder for a vehicle; and
wherein the response comprises information relating to service for the vehicle.

20. The method of claim 3 wherein the data relates to a video game; and
wherein the response comprises at least one of information relating to the video game and purchasing of goods and services.

21. The method of claim 3 wherein the data relates to a medical information system; and
wherein the response comprises at least one of information relating to personal and medical information relating to a patient.

22. The method of claim 3 wherein the data relates to an electronic commerce system; and
wherein the response comprises information relating to a financial transaction.

23. The method of claim 3 wherein the data relates to an audio recording of wildlife; and
wherein the response comprises information relating to the type of wildlife recorded.

24. The method of claim 3 wherein the data relates to a parcel of real estate; and
wherein the response comprises information relating to the size of the parcel of real estate and planting information for the real estate.

25. The method of claim 3 wherein the data relates to at least one of light spectrum of indoor lighting and a plant; and
wherein the response comprises information relating to at least one of the plant and the lighting.

26. The method of claim 3 wherein the data relates to a celebrity; and
wherein the response comprises at least one of information relating to the celebrity and the recording of a vote for the celebrity.

27. The system of claim 1 wherein the cellular telephone further includes a system function key.

28. A method for providing physiological information, comprising the steps of:
recording physiological data;
utilizing an electronic communication network to transmit the recorded physiological data to at least one remote server;
decoding the physiological data at the remote server to generate a corresponding dataset;
processing the dataset at the remote server in a predetermined manner to generate a response corresponding to the dataset; and
sending the response from the remote server to a predetermined recipient by means of the electronic communication network.
